(19) United States
(12) Patent Application Publication
(10) Pub. No.: US 2005/0002677 A1
(43) Pub. Date: Jan. 6, 2005

(54) Methods and apparatus for monitoring the strength of carriers in an optical communication system

(75) Inventors: Abraham R. McAllister, Cambridge, MA (US); Michael A. Butler, Andover, MA (US); Stephen D. Senturia, Brookline, MA (US)

Correspondence Address: Jeffrey B. Powers;Lowrie, Lando & Anastasi, LLP, One Main Street, Cambridge, MA, 02142, US

(73) Assignee: Polychromix, Inc., Woburn, MA (US)

(21) Appl. No.: 10/613,284

(22) Filed: Jul. 3, 2003

(51) Int. Cl. H04B 10/04

(52) U.S. Cl. 398/197

(57) ABSTRACT

A strength monitor for a wavelength-division multiplexed (WDM) communication system in which the carriers comprising WDM signal do not need to spatially separated to determine their strengths. The strength monitor provides local modulation of a carrier to measured. In some embodiments, a strength monitor uses a digital channel equalizer to modulate a given carrier whose strength is to be measured.

### BACKGROUND OF INVENTION

1. Field of Invention

The present invention is related to methods and apparatus for monitoring the performance of optical communication systems, and more particularly to methods and apparatus for monitoring the strengths of individual carriers of wavelength-division multiplexed signals.

2. Discussion of Related Art

Wavelength-division multiplexed (WDM) signals are comprised of two or more optical carriers (also referred to herein simply as carriers). Each carrier has a unique wavelength, and is power-modulated to transmit a data signal. In optical communications systems transmitting such WDM signals, the powers of the data signals of the individual carriers throughout the system are indicative of the system's performance. For example, a low carrier power may be the result of a component (e.g., a laser or an amplifier) operating improperly or a low carrier power may be the result of the transmission characteristics of various components that a given carrier encounters as it travels through the system. Accordingly, a low carrier power may indicate a need to replace a component, or a need to compensate for system performance (e.g., by increasing the output from a source or an amplifier), or may simply provide insight into the functioning of a system.

In WDM systems, the powers of carriers have been traditionally determined by, first, spatially separating the carriers (e.g., using a diffraction grating), and then measuring the powers of one or more of the spatially-separated carriers using conventional techniques. However, other schemes for determining the powers of the carriers have also been proposed. For example, optical communications system 100 in FIG. 1 is capable of measuring the power of individual carriers of a WDM signal without a need to spatially separate the carriers at the time of measurement, thus obviating the difficulty and expense (e.g., componentry and alignment) associated with spatially separating carriers before measurement.

In system 100, sources 102a and 102b generate a first carrier and a second carrier, respectively, and modulators 104a and 104b modulate the power of the first carrier and the power of the second carrier, respectively, such that each carrier has a unique code (i.e., a carrier identifier). The power of the first carrier and the power of the second carrier are then further modulated with data signals using modulators 108a and 108b, respectively (data modulation). Modulators 104a and 104b are located proximate to sources 102a and 102b such that the carrier identifier is applied before application of the data signals by modulators 108a and 108b.

The ratio of the depth of the code modulation to the depth of the data modulation is set to a selected value. For a selected carrier, the code modulation is selected to be both lower in depth and lower in modulation frequency than its corresponding data signal modulation, to reduce the likelihood of corruption of data in the data signal.

After each carrier is modulated with its respective code and data, multiplexer 110 combines the carriers to form a WDM signal, and the carriers are transmitted through optical fiber 125. Although not illustrated, system 100 may include any number of optical add/drop modulators (OADMs), such that a given carrier may follow a non-predetermined path through system 100. Ultimately, the first carrier and the second carrier are separated by a demultiplexer 120 and detected by receivers (Rx) 122a and 122b, respectively.

During transmission through optical fiber 125, the first carrier and second carrier may be amplified in a conventional manner, for example, using one or more erbium-doped fiber amplifiers (EDFAs) 114 and 118. At one or more locations along fiber 125, the power of an individual carrier may be determined using one or more monitors, such as monitors 112 and 116.

Each of the monitors 112 and 116 taps a portion of the total WDM signal and converts the tapped portion of the WDM signal to an electrical signal whose amplitude is proportional to the power of the WDM signal. Measurement of the power of a given carrier is achieved by applying a signal processing filter corresponding to the given carrier's code, to obtain an output signal having an amplitude corresponding to the given carrier's power. A set of filters, one for each of the carriers' codes, may be stored in a preprogrammed database at a monitor location, such that a selected filter may then be applied by a monitor to determine the power of a corresponding, selected one of the carriers. To maintain flexibility to measure power of any carrier at a selected monitor 112, 116, modulators 104a and 104b continuously modulate each carrier of a WDM signal.

In one example of such a system, the codes are pseudo-random codes (i.e., codes of “ones” and “zeros” whose time-averaged power is equal to “one-half”). In such a system, to determine the powers of individual carriers, a WDM signal is sampled in accord with the modulation frequency of the code; and the sampled data is correlated with a filter corresponding to a selected carrier's code. Because the code is pseudo-random, all carriers except the carrier correlated to the selected code will have a time-averaged value equal to one-half. The resultant filtered output signal will have an amplitude corresponding to the code modulation depth of the carrier that corresponds to the selected code. Once the depth of the code modulation is determined, a known ratio between the depth of the code modulation and the carrier power may be applied to determine the carrier power.

Despite eliminating the need to spatially separate the carriers to measure carrier power, systems such as system 100 require that information (e.g., a ratio of code modulation depth to carrier power, a code modulation frequency, codes and/or code filtering information) be provided to monitors 112 and 116 to allow appropriate calculations to be made. In such systems, the information may be stored locally (i.e., at the monitor sites) or communicated between modulators 104a and 104b, and monitors 112 and 116 by a remote communications module 106 through a fiber optic span 107 or other link.

In a system having locally stored information, if the information is to be updated due to a system modification (e.g., due to the addition of another carrier or a change in code modulation), modulators 104a, 104b and monitors 112, 116 must be physically accessed and updated with the new information necessary to appropriately modulate the carriers and calculate carrier power. In a system such as system 100, modulators 104a and 104b may be separated by a large portion of the end-to-end length of the system (e.g., 100's or 1000's of kilometers). Although a system having a remote communications system 106 alleviates the need to physically access monitors 112, 116 for the purpose of updating, a remote communications scheme is expensive to implement, and transmission of the information may be degraded or destroyed during transmission between modulators 104a and 104b, and monitors 112, 116.

Additionally, in a system such as system 100, if the power of each carrier is to be measured, a code is applied to each carrier prior to generation of the WDM signal by multiplexer 110 (i.e., using a corresponding modulator 104a, 104b), and the degree of modulation of the codes must be sufficient to be detected throughout the entire system. Accordingly, a drawback of such systems is the presence of a low frequency modulation which, although having a relatively low power, results in a noise component in signals detected by receivers 112a, 112b. Furthermore, because each code is unique, a monitor 112, 116 stores and applies a filter corresponding to each of the codes to calculate the powers of the carriers. Accordingly, as the number of carriers in WDM signals increases, the burden associated with the codes increases.

What is needed is a measurement system capable of measuring the powers of individual carriers of a WDM signal without a need to spatially separate the carriers at the time of measurement, having an improved technique for calculating power of a carrier, an improved technique for updating information used for calculating power of a carrier, and/or a reduced amount of noise introduced by the measurement system.

### SUMMARY OF INVENTION

Aspects of the present invention are directed to an optical communications system that is capable of measuring the strength of carriers in a WDM signal without a need to spatially separate the carriers at the time of measurement, in which carrier identifiers are applied after formation of a WDM signal. Accordingly, carrier identifiers are applied after data modulation of the carriers, and may occur at locations remote from the sources, such that the degree of modulation may be reduced relative to a system in which identifiers are applied at the source. The noise introduced by the measurement system may thereby be reduced. The term “strength of a carrier” is defined herein to include the power of the carrier, energy of the carrier, photon count of the carrier, a quantity proportional to one of the above, or any other suitable indicator of the vigor of the carrier.

In some embodiments, the modulation which provides a carrier identifier is applied using one or more components of a dynamic channel equalizer (DCE), such that when the carriers are separated for the purpose of channel equalization, the carriers are also modulated with a carrier identifier. Accordingly in communication systems having a DCE, modulation of the carriers may be achieved without adding additional components to spatially separate and apply a carrier identifier to a carrier to be monitored.

Additional aspects of the present invention are directed to an optical communications system that is capable of determining the strength of any carrier of a WDM signal without a need to spatially separate the carriers at the time of measurement, in which only a selected subset of the transmitted carriers are selectively modulated with a carrier identifier at a given time. In some embodiments in which only a subset of carriers are modulated with a carrier identifier at a given time, the ability to selectively measure any selected carrier at a given location is maintained by locating the modulators that provides the carrier identifiers remote from the source and, preferably, proximate to a given monitor. Accordingly, the carriers to be measured can be selectively modulated at a given site. Additionally, local modulation allows modulation of the carriers to be modulated to a lesser degree, such that measurement at one modulation site does not substantially affect modulation and measurement at another monitor site and noise contribution introduced by the measurement system is thereby reduced relative to a system in which identifiers are applied at the source. A “subset of carriers” is defined herein to mean one or more of the carriers of a WDM signal, but less than all of the carriers of the transmitted WDM signal.

In some embodiments, only a single carrier is modulated with a carrier identifier, thus reducing the amount of calculation necessary to determine carrier strengths. In some embodiments, a single carrier identifier is applied to a plurality of carriers sequentially, so that all carriers can be measured using a single carrier identifier. Because carriers may be selectively modulated with a carrier identifier, the modulation of the carriers may be terminated when monitoring is complete, thereby reducing the noise resulting from the carrier identifier modulation.

A first aspect of the invention is directed to an apparatus to process a plurality of spatially-separated, data-modulated carriers of a wavelength-division multiplexed (WDM) signal, comprising: a plurality of optical modulators arranged so that each receives a corresponding one of the plurality of data-modulated carriers; and a control module adapted to actuate at least one of the plurality of optical modulators such that a carrier identifier is applied to at least one of the plurality of carriers, whereby the at least one of the plurality of data-modulated carriers is modulated with data and a carrier identifier.

Optionally, the apparatus further may comprise a demultiplexer configured to receive the WDM signal and form the plurality of spatially-separated carriers. The apparatus may further comprise a multiplexer configured to receive the spatially-separated carriers from the outputs of the plurality of optical modulators and to combine the spatially-separated carriers to form a second WDM signal. In some embodiments, the apparatus further comprises: an optical tap optically coupled to the multiplexer output and arranged to tap a portion of the second WDM signal; and a photosensor to transduce the tapped portion of the second WDM signal and form a transduced signal; and a strength calculation module configured to receive the transduced signal and to calculate the strength of the at least one of the plurality of carriers.

In some embodiments, the strength calculation module comprises a rectifier and an integrator that together determine the strength of the at least one of the plurality of carriers. In some embodiments, the strength calculation module further comprises a bandpass filter to selectively pass a portion of the transduced signal corresponding to the carrier identifier, and to provide the portion of the transduced signal to the rectifier. The modulators may be comprised of actuatable grating elements of a diffraction grating. The diffraction grating may be a diffraction grating of a dynamic channel equalizer. In some embodiments, the control module applies the carrier identifier to only a selected one the plurality of data-modulated carriers during a selected time interval. In some embodiments, the control module controls each of the plurality of modulators with a corresponding electronic signal having a DC component, and a selected one of the plurality of modulators corresponding to the selected one of the plurality of carriers with an AC component to apply the carrier identifier, whereby the channels are equalized and the selected one of the plurality of carriers is modulated.

Another aspect of the invention is directed to an apparatus for processing a plurality of spatially-separated, data-modulated carriers of a wavelength-division multiplexed (WDM) signal, comprising: a plurality of optical modulators arranged so that each receives a corresponding one of the plurality of data-modulated carriers; and a control module adapted to modulate only a selected subset of the plurality of optical modulators during a given time interval, so as to apply a corresponding carrier identifier to each of a subset of the plurality of data-modulated carriers, whereby each of the subset of carriers is modulated with data and a carrier identifier.

In some embodiments, the selected subset of the plurality of optical modulators consists of only one of the optical modulators. The system may further comprise a spectral demultiplexer configured to receive the WDM signal and form the plurality of spatially separated carriers. Optionally, the control module may be adapted to modulate at least two of the plurality of modulators to apply a common carrier identifier to each of a corresponding at least two of the plurality of carriers, application of the common identifier to a first of the at least two of the plurality of carriers and a second of the at least two of the plurality of carriers occurring sequentially.

Yet another aspect of the invention is directed to an apparatus for processing a plurality of spatially-separated carriers of a wavelength-division multiplexed (WDM) signal, comprising: a plurality of optical modulators, each arranged to receive a corresponding one of the plurality of spatially-separated carriers; and a control module adapted to control a first of the plurality of optical modulators to apply a carrier identifier to a first of the plurality of the carriers, and to control a second of the plurality of optical modulators to apply the carrier identifier to a second of the plurality of the optical carriers, the modulation of the first of the plurality of optical modulators and the second of the plurality of modulators being applied sequentially.

Optionally, the apparatus further comprises a demultiplexer configured to receive the WDM signal and form the spatially-separated carriers. In some embodiments, the apparatus further comprises a multiplexer configured to receive the spatially-separated carriers from the outputs of the plurality of optical modulators and to combine the spatially-separated carriers to form a second WDM signal. In some embodiments, the apparatus further comprises: an optical tap optically coupled to the multiplexer output and arranged to tap a portion of the second WDM signal; a photosensor to transduce the tapped portion of the second WDM signal; and a strength calculation module configured to receive the transduced signal of the second WDM signal and to calculate the strength of the at least one of the plurality of carriers. Optionally, the strength calculation module comprises a rectifier and an integrator to calculate the strength of the at least one of the plurality of carriers. The strength calculation module may further comprise a bandpass filter to selectively pass a portion of the tranduced signal corresponding to the carrier identifier, and to provide the portion of the tranduced signal to the rectifier.

Still another aspect of the invention is directed to a method of processing at least one data-modulated carrier of a wavelength-division multiplexed (WDM) signal including a plurality of data-modulated carriers, comprising a step of: modulating the at least one of a plurality of data-modulated carriers with a carrier identifier, the plurality of data-modulated carriers being spatially separated. In some embodiments, the method further comprises a step of spatially-separating the plurality of data-modulated carriers prior to the step of modulating. In other embodiments, the method further comprising steps of: multiplexing the plurality of data-modulated carriers to from a second wavelength-division multiplexed (WDM) signal; tapping a portion of the second WDM signal; transducing the portion to form an electronic signal; and calculating an output indicative of the strength of the at least one of the plurality of data-modulated carriers by processing the electronic signal.

Optionally, the step of calculating an output comprises rectifying the electronic signal. The step of calculating an output may further comprise integrating the rectified electronic signal. In some embodiments, the step of modulating comprises modulating a diffraction grating. The diffraction grating may be a component of a dynamic channel equalizer.

Another aspect of the invention is directed to a method of measuring the strength of one of a plurality of carriers comprising a wavelength-division multiplexed (WDM) signal, using a dynamic channel equalizer (DCE) including a plurality of actuatable elements, comprising steps of: equalizing the strengths of the plurality of carriers by actuating at least one of the plurality of actuatable elements; and modulating the one of the plurality of carriers with a carrier identifier.

In some embodiments, the method further comprising a step of demultiplexing the plurality of carriers to spatially separate the plurality of carriers prior to the step of equalizing and the step of modulating. In other embodiments, the method further comprises a step of multiplexing the plurality of plurality of carriers to from a wavelength-division multiplexed (WDM) signal, the step of multiplexing occurring after the step of equalizing and the step of modulating.

The step of equalizing and the step of modulating may be achieved at the same time by actuating the grating elements of a diffraction grating. Optionally, the method may further comprise a step of tapping a portion of the WDM signal, and a step of transducing the tapped portion to form an electronic signal, the step of tapping and the step of transducing occurring after the step of tapping. In some embodiments, the method further comprises a step of calculating an output indicative of the strength of the one of the plurality of carriers by processing the electronic signal. Optionally, the step of calculating may comprise a step of rectifying the electronic signal and a step of integrating the rectified signal.

### BRIEF DESCRIPTION OF DRAWINGS

The accompanying drawings, are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram illustration of a conventional optical communications system capable of determining the powers of individual carriers of a WDM signal without spatially separating the carriers at the time of measurement;

FIG. 2 is a block diagram of an exemplary embodiment of an optical communications system according to some aspects of the present invention which is capable of determining the strengths of individual carriers of a WDM signal without spatially separating the carriers at the time of measurement;

FIG. 3 is a block diagram of an exemplary embodiment of an optical carrier strength monitor according to some aspects of the present invention;

FIG. 4a is a block diagram of an exemplary embodiment of a strength calculation module according to at least some aspects of the present invention;

FIGS. 4b-4f are graphical illustrations of exemplary signals from the strength calculation module illustrated in FIG. 4a;

FIG. 5a is a schematic illustration of an exemplary embodiment of a dynamic channel equalizer (DCE) suitable for use as a modulator to apply a carrier identifier;

FIG. 5b is a simplified and magnified plan view of an exemplary microelectromechanical system (MEMS) diffraction grating device suitable for use in the DCE illustrated in FIG. 5a;

FIG. 5c is a simplified and magnified side view of an exemplary microelectromechanical system (MEMS) diffraction grating device suitable for use in the DCE illustrated in FIG. 5a;

FIG. 6 is a schematic illustration of an exemplary embodiment of a strength calculation module according to at least some aspects of the invention; and

FIG. 7 is a schematic illustration of a WDM signal strength monitor.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

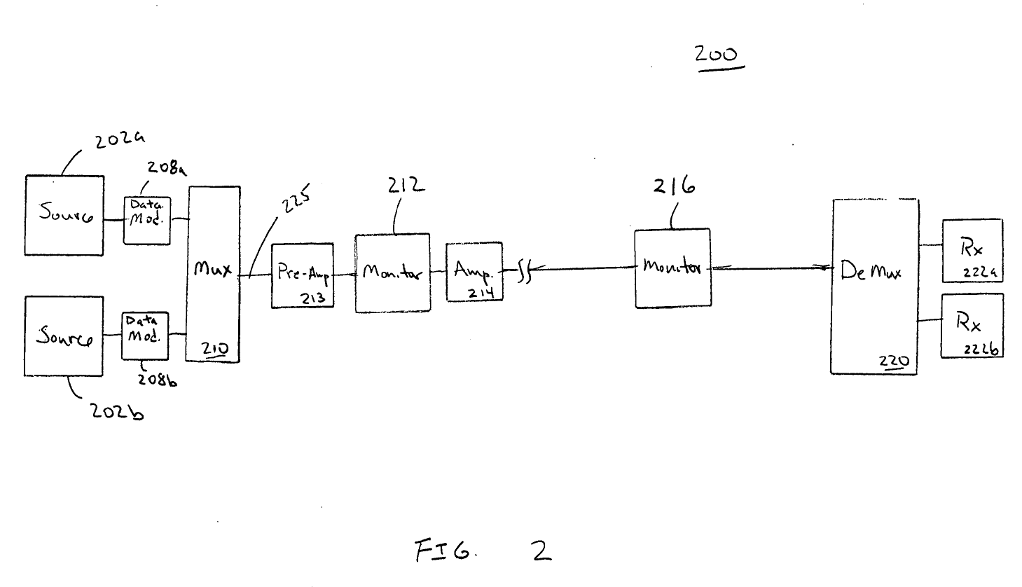

FIG. 2 is a block diagram of an exemplary embodiment of an optical communications system 200 according to some aspects of the present invention. Communications system 200 is capable of measuring the strengths of individual carriers of a WDM signal without a need to spatially separate the carriers at the time of measurement. As described in greater detail below, according to aspects of the invention, a carrier identifier is applied to a carrier after data modulation. System 200 is comprised of sources 202a and 202b, modulators 208a and 208b, a multiplexer 210, monitors 212 and 216, a demultiplexer 220, and receivers (Rx) 222a and 222b.

In system 200, sources 202a and 202b generate a first carrier and a second carrier, respectively. The power of the first carrier and the power of the second carrier are then modulated with data signals using modulators 208a and 208b, respectively. After each carrier is modulated with its respective data, multiplexer 210 combines the carriers to form a WDM signal, and the carriers are transmitted through optical fiber span 225. Although not illustrated, system 200 may include any number of optical add/drop modulator (OADMs) or other switching devices, such that a given carrier may follow a non-predetermined path through system 200.

Ultimately, the first carrier and the second carrier are separated by a demultiplexer 220 and detected by receivers (Rx) 222a and 222b, respectively. During transmission through optical fiber 225, the first carrier and second carrier may be amplified in a conventional manner, for example, using one or more erbium-doped fiber amplifiers (EDFAs) 214. In addition to the components described above, system 200 may include any suitable, conventionally known or yet-to-be-developed optical communications elements.

Along fiber 225, the strength of an individual carrier may be measured using one or more signal strength monitors 212, and 216, to determine the strengths of individual carriers of a WDM signal without a need to spatially separate the carriers at the time of measurement. Monitors 212 and 216 are discussed in greater detail with reference to subsequent figures.

Aspects of the present invention are directed to an optical communications system that is capable of measuring the strength of carriers in a WDM signal without a need to spatially separate the carriers at the time of measurement, in which a carrier identifier is applied after formation of a WDM signal. Accordingly, the carrier identifier is applied after data modulation of the carrier. A modulator (not shown) that applies a carrier identifier after data modulation is referred to herein as being “remote from the source.” It is to be appreciated that the modulation amplitude of an identifier need only be sufficient to reach a measurement location, thus by applying a carrier identifier remote from sources 202a and 202b, the modulation amplitude may be reduced relative to a system in which modulation occurs at the source (i.e., prior to data modulation), thereby reducing the noise resulting from application of a carrier identifier. In some embodiments, application of the carrier identifier is locally applied (i.e., occurs within a selected one of monitor 212 and 214 where carrier strength is to be measured). An example of an embodiment of a monitor 212 which has modulators 322a-322c configured to locally apply a carrier identifier is monitor 312 illustrated in FIG. 3, which is described in greater detail below.

Referring again to FIG. 2, system 200 includes preamplifier 213 and amplifier 214. In some embodiments a monitor 212, 216 is located after preamplifier 213 and before amplifier 214. However, the invention is not so limited, and monitor 212 may be located at any suitable location.

FIG. 3 is a block diagram of an exemplary embodiment of an optical carrier strength monitor 212 according to some aspects of the present invention. Monitor 212 is comprised of a demultiplexer 310, a modulation module 320 comprising a plurality of modulators 322a-322c, a multiplexer 330, a tap 340, a strength calculation module 350, and a modulator control module 360.

The carriers of a wavelength-division multiplexed (WDM) signal are transmitted along fiber span 225 and are spatially-separated by demultiplexer 310. Each modulator 322a-322c receives a corresponding one of the spatially-separated carriers. As described in greater detail below, modulators 322a-322c are controlled by control module 360 so as to modulate one or more of the spatially-separated carriers to apply a unique carrier identifier to each of one or more of the carriers. Accordingly, each of the carriers modulated by modulator 322 is modulated with data and a unique carrier identifier.

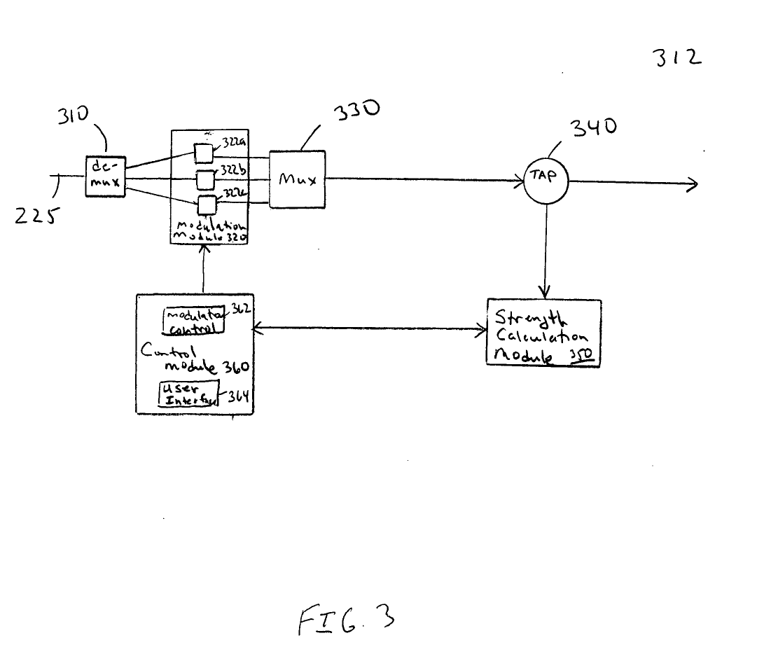

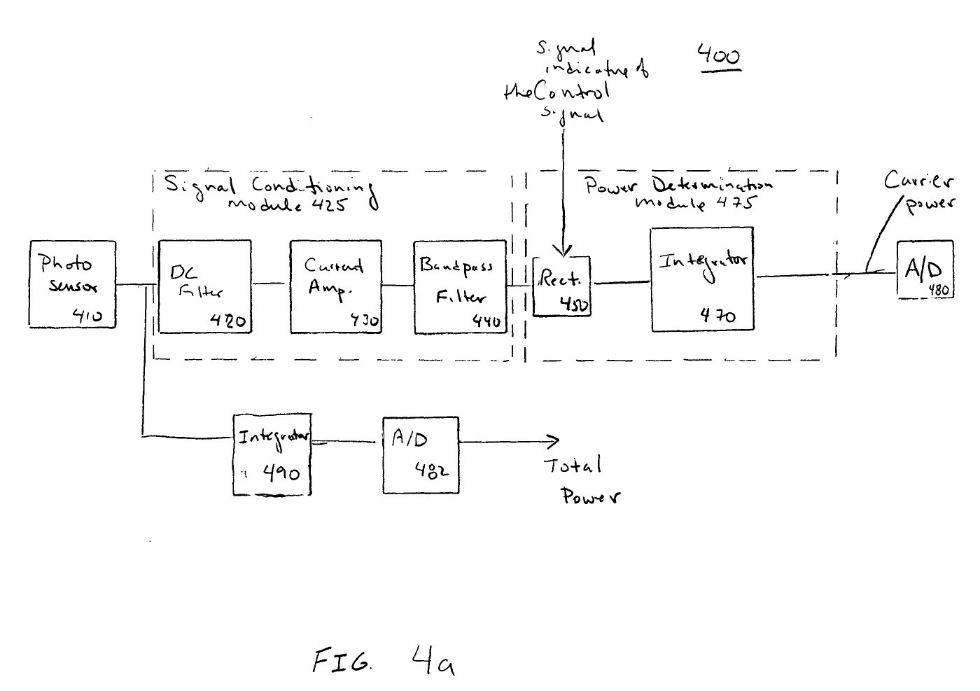

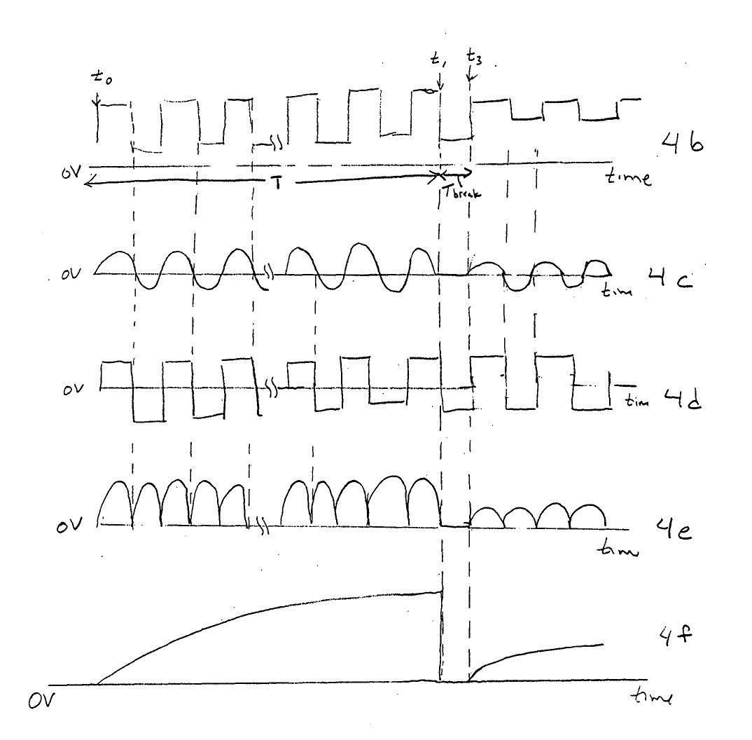

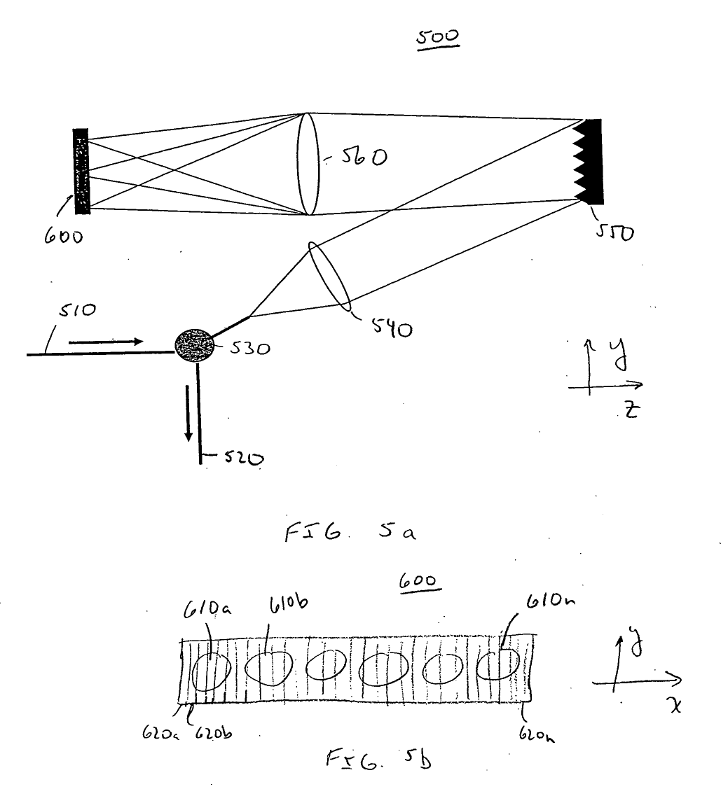

The carriers are then re-multiplexed by multiplexer 330 to form a second WDM signal. Subsequently, a portion of the second WDM signal may be tapped by tap 340 and transmitted to strength calculation module 350 to calculate the strength of the at least one of the plurality of carriers. Strength calculation module is described in greater detail with reference to FIG. 4 below.

Demultiplexer 310 may be any suitable device capable of spatially-separating the carriers of a WDM signal. As one of ordinary skill in the art would understand, demultiplexer 310 is typically selected to have suitable angular divergence, polarization, and transmission characteristics. For example, demultiplexer 310 may be a diffraction grating or a prism. Multiplexer 330 may be a device similar to demultiplexer 310, having light carriers appropriately directed onto it so as to recombine the carriers.

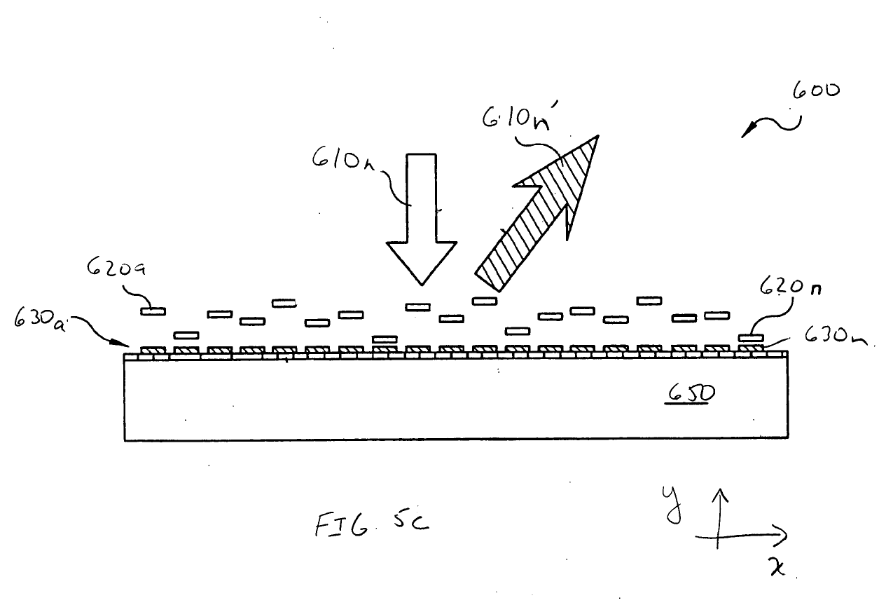

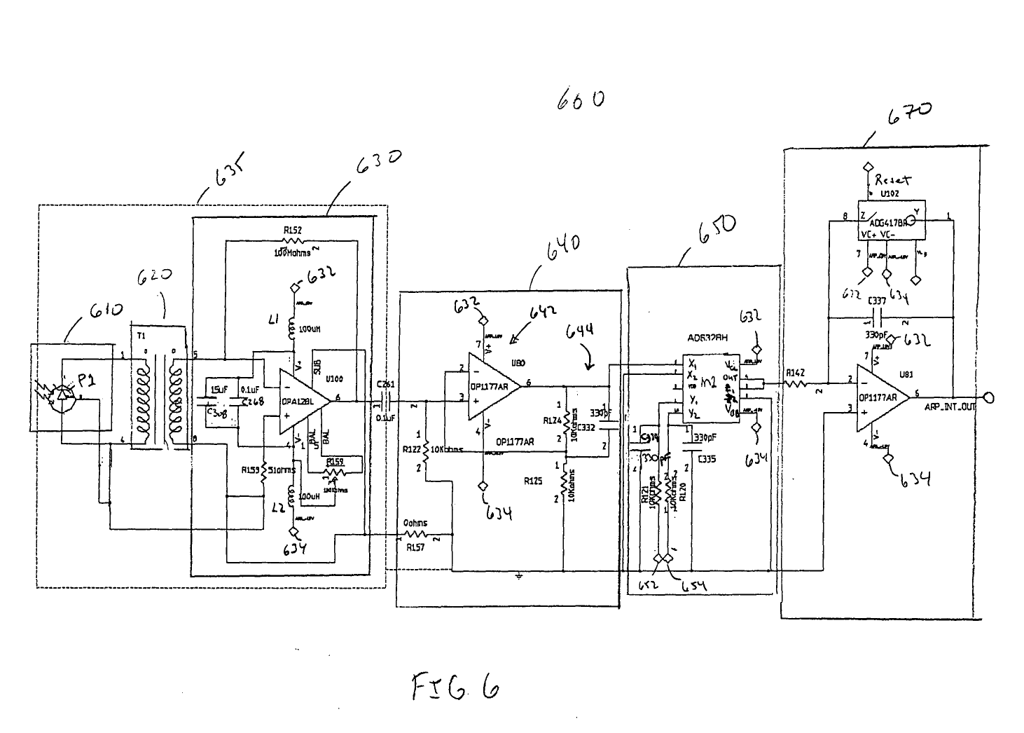

Modulators 332a-332c may be any modulators suitable for modulating the strength of the spatially-separated carriers of a WDM signal so as to apply a carrier identifier. Modulation may be achieved using any suitable optical effect. For example, modulation may be achieved by altering the reflection, diffraction, or absorption of modulators 322. As discussed in greater detail below with reference to FIGS. 5a-5c, in some embodiments, modulators 322 are comprised of actuatable diffraction grating elements.

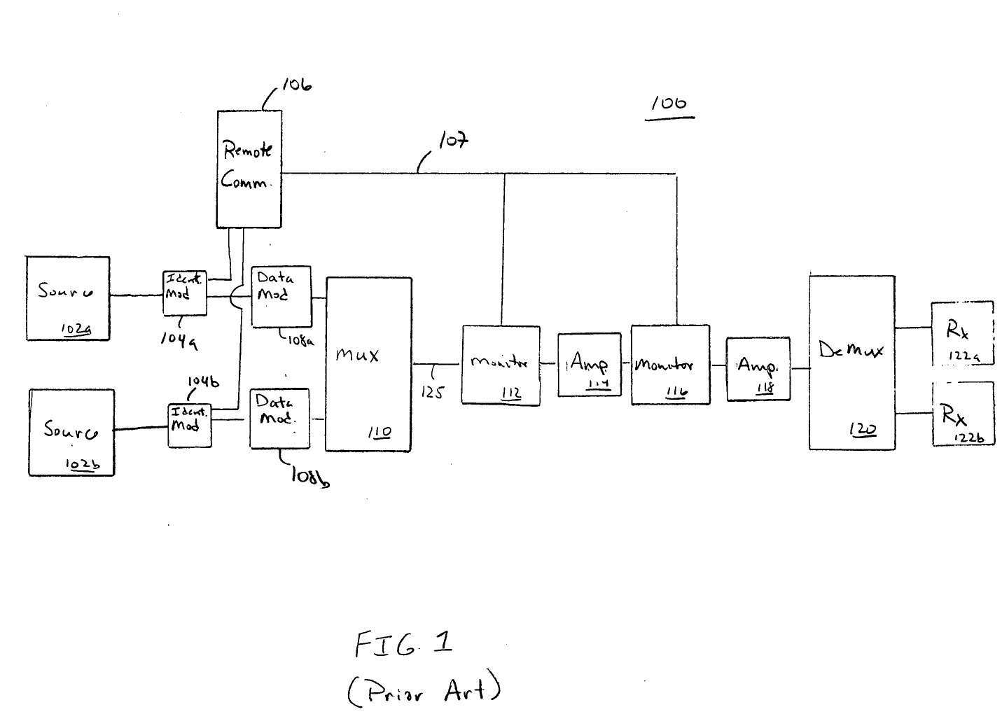

Modulators 322 modulate the strengths of the carriers of the WDM signal. For a selected carrier, the carrier identifier modulation is typically selected to be both lower in amplitude and lower in modulation frequency than the data signal, to reduce the likelihood of corruption of data in the data signal. As discussed above, the carrier identifier modulation amplitude may be significantly lower than that in the prior art system discussed above with reference to FIG. 1, due to the fact that the carrier identifiers are applied at locations remote from the sources 202a, 202b (shown in FIG. 2). The difference in the data modulation frequency and the carrier identifier frequency may be any amount suitable to avoid corruption, and may be several orders of magnitude different. For example, the data modulation rate may be in the gigahertz range and the carrier identifier may be in the tens of kilohertz range.

In some embodiments, modulators 322 that apply carrier identifiers are located one foot to a few meters away from the location of measurement (e.g. in a single building). For example, the location of measurement is indicated by tap 340, which provides a portion of the WDM signal to strength calculation module 350. It is to be appreciated that in such systems, updating information used for calculating power of a carrier may be greatly facilitated due to the proximity of modulators 322 to strength calculation module 350.

Control module 360 may be comprised of any suitably programmed processor capable of selectively actuating modulators 322a-322c to generate carrier identifiers in accordance with aspects of the present invention. In the illustrated exemplary embodiment, control module 360 includes a modulator control module 362 and may include a user interface 364.

Optical tap 340 is optically coupled to the output of multiplexer 330 and arranged to tap a portion of the WDM signal formed by multiplexer 330. Tap 340 may be any suitable tap capable of diverting a portion of a WDM signal from the remainder of the signal. For example, the tap may divert one percent of the WDM signal.

User interface 364 may be any suitable interface capable of allowing a user to select one or more carriers whose strength is to be measured. User interface 364 may include a keypad, switches, a graphical user interface or any other suitable input for selecting the carriers to be measured. Additionally, user interface may include a suitable device for displaying an indication of strengths of the selected carriers (e.g., a cathode ray tube or a liquid crystal display).

Modulation control module 362 generates a suitable signal for controlling modulators 322a-322c. For example, modulation control module 362 may provide an electrical signal (having a suitable voltage and current), or an optical, radio-frequency or infrared signal to control modulator 322.

Control module 360 is connected to strength calculation module 350 to receive a signal indicative of the calculated strength. The signal indicative of strength may be comprised of an analog signal having an amplitude indicative of a carrier strength, or may provide a digital representation of carrier strength.

Additionally, control module 360 may provide a signal indicative of the control signal used to control modulators 322a-322c, which may be used by strength calculation module 350 to calculate the strength of a carrier as described in greater detail below with reference to FIGS. 4b-4f. For example, the signal transmitted to strength calculation module 350 may indicate the phase and frequency of the control signal used to control the modulators. In some embodiments, the signal is a synchronous copy of the signal used to control modulators 322.

While in some embodiments, control module 360 indicates to calculation module 350 the phase and frequency of the control signal used to control the modulators, the invention is not so limited. For example, in some embodiments the strength calculation module 350 may have an a priori indication of the control signal or may derive such information from the optical signal (or a corresponding electrical signal) such that phase and frequency of the control signal need not be provided by control module 360 to strength calculation module 350.

In some embodiments of the invention, control module 360 is adapted to modulate only a selected subset of the plurality of optical modulators 322 so as to apply a corresponding carrier identifier to each of the subset of the plurality of carriers, whereby each of the subset of carriers is modulated with data and a carrier identifier. It is to be appreciated that application of a carrier identifier remote from carrier sources 202a and 202b (as illustrated in FIG. 2) according to aspects of the invention permits modulation of only a subset of the carriers at a selected monitor (e.g., monitor 212), at a given instance of time, while maintaining the flexibility to measure the strength of any selected carrier at another monitor (e.g., monitor 216) (illustrated in FIG. 2). For example, a modulator 322 is located proximate the location of a monitor 212 and selected to have a modulation depth so as to avoid affecting measurement at another monitor 216. As one of ordinary skill in the art would understand, selecting a modulation depth such that one monitor site does not affect measurements on another site is dependent on modulation depth and distance between monitor sites.

In some embodiments, modulation control module 360 is adapted to actuate a first of the plurality of optical modulators 322 (e.g., modulator 322a) to apply a carrier identifier to a first of the plurality of the carriers of a WDM signal, and to actuate a second of the plurality of optical modulators (e.g., modulator 322b) to apply the same carrier identifier to a second of the plurality of the optical carriers. In such embodiments, the actuation of the first of the plurality of optical modulators and the actuation of the second of the plurality of modulators 322 are achieved sequentially. It is to be appreciated that a modulation control module 362 so adapted may provide the ability to use strength calculation techniques that are less complex than the prior art monitor illustrated in FIG. 1 in which each carrier is modulated with a corresponding, unique carrier identifier.

Strength calculation module 350 may employ any suitable technique to calculate the strength of a modulated one of the plurality of carriers, using the tapped portion of the WDM signal received from tap 340. One example of a strength calculation module 350 is described below with reference to FIG. 4a. The exemplary strength calculation module 350 transduces the WDM signal and determines the strength of a selected carrier using electronic signal processing. Although the exemplary module uses electronic processing, the invention is not so limited and a suitable optical processing technique may be used.

FIG. 4a is a block diagram of an exemplary embodiment of a strength calculation module 400 according to at least some aspects of the present invention. Strength calculation module 400 is comprised of a photosensor 410, a signal conditioning module 425, and strength determination module 475. Although portions of the discussion below assume an analog implementation of a strength calculator module 400, it should be appreciated that one or more of the components may be digitally and/or software implemented.

Photosensor 410 transduces the portion of the WDM signal diverted by tap 340 (illustrated in FIG. 3) to produce an electronic output having an amplitude proportional to the strength of the WDM signal (i.e., including all carriers of the WDM signal). Photosensor 410 may be any suitable optical transducer, such as a photodiode.

Signal conditioning module 425 modifies the signal to facilitate processing by strength determination module 475. For example, signal conditioning module may be processing circuit capable of selectively passing the portion of the WDM signal having a frequency equal to the carrier identifier modulation frequency. In the illustrated embodiment, signal conditioning module 425 is comprised of a DC filter 420, a current amplifier 430, and a bandpass filter 440.

DC filter 420 removes the DC component of the transduced signal. DC filter 420 may be comprised of any suitable DC-blocking component such as a transformer or a capacitor. Current amplifier 430 may be any suitable amplifier capable of achieving an adequate signal amplitude for subsequent processing. Band-pass filter 440 passes a portion of the transduced signal corresponding to the frequency of the carrier identifier applied by modulator 322 (shown in FIG. 3).

Strength determination module 475 may be any processor capable of determining the strength of a modulated carrier. In the illustrated exemplary embodiment, strength determination module 475 is comprised of a rectifier 450, and an integrator 470.

Rectifier 450 may be any suitable device capable of modifying the signal conditioning module 425 output to have a single polarity. For example, the rectifier may be a multiplier that receives a signal indicative of the control signal used to control modulators 322a-322c (illustrated in FIG. 3). As stated above, the signal transmitted to strength calculation module 350 may indicate the phase and frequency of the control signal used to control the modulators, and in some embodiments, the signal may be a synchronous copy of the signal used to control modulators 322. The operation of rectifier 450 and integrator 470 are described in greater detail below with reference to FIGS. 4b-4f.

For example, integrator 470 may be a low-pass filter having a suitably long time constant, so as to integrate the output of multiplier 450 for a selected time period. In some embodiments, the integrator output is digitized by an analog-to-digital (A/D) converter 480, such that the signal indicative of the strength of a selected carrier is provided to control module 360 (shown in FIG. 3) in a binary format.

Additionally, in some embodiments, an integrator 490 integrates the output of photosensor 410 to provide a signal having an amplitude indicative of the strength of the WDM signal (i.e., including all carriers) transmitted in communication system 300 (illustrated in FIG. 3). A second A/D converter 482 may be used to digitize the signal indicative of the strength of the WDM signal.

FIGS. 4b-4f elucidate an exemplary measurement technique for determining the strength of a given carrier. Measurement is achieved by applying a signal processing filter corresponding to the given carrier's carrier identifier, to obtain an output signal (shown in FIG. 4a) having an amplitude indicative of the given carrier's strength.

FIGS. 4b-4f are graphical illustrations of exemplary signals at various locations in strength calculation module 400. Accordingly, the discussion of FIGS. 4b-4f is made with reference to the exemplary strength determination module illustrated in FIG. 4f. The illustrated waveforms are not drawn to scale.

Although the discussion below occurs with reference to a system employing a single carrier identifier, as described above, in some embodiments of the invention, techniques employing multiple carrier identifiers (e.g., one for each carrier of a WDM signal) may be made used. One example of a system capable of using multiple carrier identifiers is described in U.S. Pat. No. 5,513,029, titled METHOD AND APPARATUS FOR MONITORING PERFORMANCE OF OPTICAL TRANSMISSION SYSTEMS, by Roberts, the substance of which is hereby incorporated by reference.

FIG. 4b illustrates an exemplary output of photosensor 410. The signal illustrated in FIG. 4b is illustrated at a scale to facilitate viewing of the carrier identifier and, data modulation is omitted to avoid obfuscation. As stated above, the carrier identifier modulation is typically lower in frequency and lower in amplitude than the data modulation. In the illustrated example, a square-wave carrier identifier modulation is assumed.

The waveform of FIG. 4b illustrates that carrier identifier modulation is applied to a selected carrier for a predetermined amount of time T. Typically, time T is selected to be long enough to allow power measurements to be made by averaging many carrier identifier modulation cycles. For example, the measurement time T may be one second in duration and the carrier identifier modulation rate may be 2000 cycles/second.

FIG. 4b illustrates measurement of a first carrier beginning at time to and ending at time t₁. A second measurement begins at time t₃. The carrier measured at time t₃ may be the same carrier as in time span t₁ to t₂ (i.e., a re-measurement), or may be a different carrier.

FIG. 4c illustrates an exemplary signal taken at the output of band pass filter 440. Because band pass filter 440 is located downstream of DC filter 420, the signal has no DC bias. Additionally, processing by band pass filter 440 results in the removal of high frequencies associated with the square wave signal illustrated in FIG. 4b. As a result, the waveform illustrated in FIG. 4c is centered about zero volts, and has edges that are more rounded than those illustrate in FIG. 4b. The amplitude of the signal illustrated in FIG. 4c is proportional to the strength of the selected modulated carrier.

As one of ordinary skill would understand, if the degree of modulation (e.g., the amount of attenuation in dBs) applied at modulation module 320 (shown in FIG. 3) is constant, the modulation amplitude of the carrier identifier, as measured at photosensor 410, will vary depending on the strength of the carrier being modulated with the carrier identifier. However, provided the total strength of the WDM signal comprising the carriers remains substantially constant, the DC offset of the composite signal will remain substantially constant, regardless of the strength of the carrier in the WDM signal that is modulated with the carrier identifier.

For the purposes of illustration, rectifier 450 is assumed to be an analog multiplier having two inputs: a square wave multiplier signal is applied to the first input and the band pass filter output (shown in FIG. 4c) is applied to the other. FIG. 4d illustrates the uniform, square-wave multiplier input signal. The square wave multiplier signal is synchronous with the signals in FIGS. 4a-4c, which were formed from transducing the optical signal. For example, as described above, the multiplier signal may be a synchronous copy of the signal provided by control module 360 to modulator 322 to apply the carrier identifier.

FIG. 4e illustrates an exemplary output from multiplier 450. As illustrated, the signal is rectified as a result of synchronization of the multiplier signal and the band pass filter output (shown in FIG. 4c). FIG. 4f illustrates an exemplary output of integrator 470. For the measurement of a first selected carrier, the integrator begins at zero volts (at time t₀), and the output after the selected measurement time (at time t₁) provides a signal indicative of the strength of a selected carrier. After the selected time, the integrator is reset to zero volts, and a second measurement begins (at time t₃).

FIG. 5a is a schematic of an exemplary embodiment of a modulation system 500 suitable for use as modulation module 320 (illustrated in FIG. 3), and controlled by module 360 (also illustrated in FIG. 3) to apply a carrier identifier. In the illustrated exemplary embodiment, modulation system 500 is a diffraction-based, dynamic channel equalizer (DCE) capable of equalizing the strengths of carriers in a WDM communication system. The illustrated DCE is comprised of a circulator 530, a collimating lens 540, a dispersive element 550, a focusing lens 560, and a microelectromechanical system (MEMS) diffraction grating device 600. Dynamic channel equalization 500 is described in greater detail in co-pending U.S. provisional patent application 60/383,641, titled TELECOMMUNICATIONS OPTICAL PROCESSOR, filed May 28, 2002, by Smith et al, the substance of which is hereby incorporated by reference.

In DCE 500 collimating lens 540 collimates the input signal and projects a collimated beam onto dispersive element 550. Focusing lens 560 is located to focus individual carriers on spatially distinct locations along MEMS device 600 in the y-direction, as illustrated.

Referring to FIG. 5b, a simplified and magnified plan view of an exemplary MEMS device 600 is illustrated. FIG. 5b illustrates illumination spots corresponding to a plurality of carriers 610a-610n projected onto the grating elements 620a-620n of MEMS device 600 at spatially distinct locations in the y-direction.

Although, the input and output signals are illustrated as being processed by a circulator 530, in some embodiments, input fiber 510 and output fiber 520 may be arranged in a conventional off-axis alignment, to receive the input signal and the output signal without the use of a circulator.

FIG. 5c is a simplified and magnified side view of one example of a MEMS diffraction grating device 600 and an exemplary carrier 610n. Device 600 includes a plurality of grating elements 576a-576n supported above a substrate 572 by a suitable, actuatable support structure (not shown). Each grating element 576a-576n has a corresponding fixed electrode 574a-574n. One example of a suitable MEMS device is described in greater detail in co-pending U.S. patent application Ser. No. 10/090,381, titled ACTUATABLE DIFFRACTIVE OPTICAL PROCESSOR, filed Oct. 11, 2001, by Deutch et al, the substance of which is hereby incorporated by reference.

Device 570 is controlled in a manner to provide equalization of carriers of a WDM signal, and according to aspects of the present invention, grating elements may be actuated, for example, in a periodic manner, so as to cause a modulation in the strength of the carriers to generate a carrier identifier as described above. Accordingly, by appropriate selection of the actuation depths of the grating elements, equalization of the carriers and application of a carrier identifier may be attained.

A voltage is established between a selected grating element 620 and its corresponding fixed electrode 630 to position the grating element to diffract a corresponding carrier 610n to form a diffracted beam 610n′. Because the voltage to establish a given amount of attenuation for the purpose of equalization remains substantially fixed over the time necessary to apply a given identifier, the combined voltage to achieve both equalization and application of the carrier identifier has an AC component and a DC offset.

Equalization may be achieved according to known techniques and a carrier identifier according to the present invention may be applied according the present invention by applying an AC signal having an appropriate amplitude to achieve a given modulation depth of a carrier to be measured.

An attenuation level having a DC component A(dB) measured in decibels and a superposed AC component ΔA(dB), also measured in decibels, has maximum and minimum attenuations determined by the equation A_{TOT}(dB)=A(dB)±ΔA(dB). The actuation depth necessary to achieve a given amount of attenuation may be determined using equation (1).
A_{TOT}(dB)=10*log[0.5(1+cos(4πh/λ))] (1)

where λ is the wavelength of the carrier to be attenuated, and h is the actuation distance necessary to achieve a given attenuation. For example, a carrier identifier modulation depth may be equal to 0.05 dB (i.e., 1%).

The voltage necessary to achieve a given actuation distance is given in equation (2).
V=\sqrt{αΔh}(1−βΔh) (2)

where Δh=h₀−h, h₀ being an integer multiple of λ/2; and α and β are constants determined by geometry and properties of a given electrostatic MEMS diffraction grating device.

Further details regarding electrostically-actuated MEMS devices is given in U.S. Pat. No. 6,329,738, titled PRECISION ELECTROSTATIC ACTUATION AND POSITIONING, issued Dec. 11, 2001, to Hung, et al., the substance of which is hereby incorporated by reference.

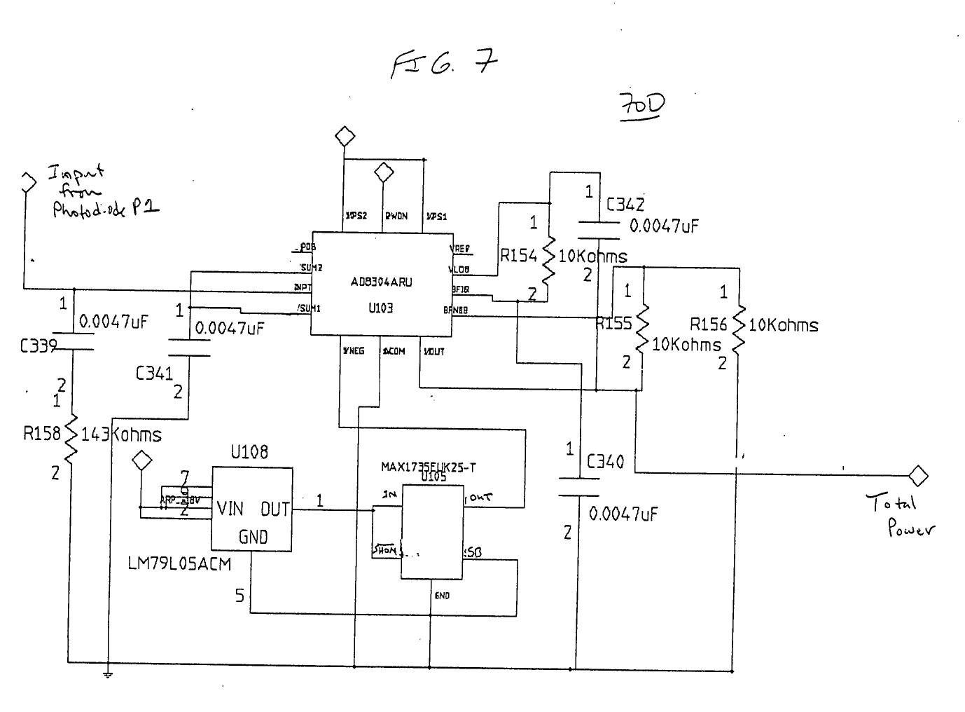

FIG. 6 is a schematic illustration of an exemplary embodiment 600 of strength calculation module 400 (shown in FIG. 4a) according to at least some aspects of the invention. As described above, strength calculation module 600 is comprised of a photosensor 610, a DC current blocking filter 620, a current amplifier 630, a band pass filter 640, a rectifier 650, and an integrator 670.

In the illustrated embodiment, photosensor 610 is comprised of a shielded photodiode P1. For example photodiode P1 may be model number M161-1-10, manufactured by Eigenlight, Inc. of Somersworth, N.H.

DC current blocking filter 620 is comprised of a transformer T1. For example, transformer T1 may be a transformer model number TIC-218 from Tamura Microtran Corporation. The tranformer has a low DC resistance (600 ohms) and is rated for 500 milliamps of current.

Current amplifier 630 is a current-to-voltage trans-impedance amplifier having components as follows:
U100 is an operational amplifier model number 0PA128L manufactured by Texas Instruments
R152=100 Mohms
C308=15 μF
C28=0.1 μF
L1=100 μH
L2=100 μH
R159 is a 180 kohms variable resistor used to set the DC offset to 0 V.

Bandpass filter 640 is comprised of a highpass filter 642 in series with a lowpass filter 644. Highpass filter 642 and lowpass filter 644 are comprised of the following components.
U80 is an operational amplifier model number 0 P1177AR manufactured by Texas Instruments
R177=10 kohms
R4=10 kohms
R125 is 10 Kohms and capacitor C332 is 330 pF.

Rectifier 650 is comprised of a multiplier M1 which is for example a multiplier model number AD632AH manufactured by Analog Devices, Inc. Multiplier M1 combines the signals from inputs X1, X2, Y1, Y2 in the following manner (X1−X2)(Y1−Y2).
R120=10 kohms
R121=10 kohms
C334=330 pF
C335 is 330 pF

Current amplifier 630 and bandpass filter 640 are separated by a DC voltage blocking capacitor C261=0.1 μF. Photosensor 610 and current amplifier 630 are surrounded by a sheet metal shield 635. A 0 ohm resistor R157 separates the ground of photosensor 610 and current amplifier 630 from the system ground used in the remaining portion of the circuit.

Integrator 670 is comprised the following components:
U81 is an operation amplifier model number OP1177AR manufactured by Texas Instruments, Inc.
R141=100 kohms
C337=330 pF
U102 is a reset switch such as model number ADG417BR manufactured by Analog Devices, Inc.

In one exemplary application of the above circuit, the light of the signal to be measured is modulated at 10 kHz (e.g., modulators 332a-332c in FIG. 3 are modulated at 10 kHz); accordingly the modulation of the signal-to-be-measured, which is output form photodiode P1, is modulated at 10 kHz. Band pass filter 640 is tuned to pass a 10 kHz signal and block the remaining frequencies. Accordingly, only the signal-to-be-measured passes. An output of band pass filter 640 is provided on input X1, and a 10 kHz square wave signal having no DC bias is provided using inputs Y1 and Y2.

As described above, the signal used to modulate modulators 332 may be used to calculate a signal indicative of carrier strength. Accordingly, in the illustrated embodiments, the signal used to modulate modulators 332 is provided to input 654 and an inverted version is provided to input 652. Integrator U81 integrates the resulting rectified signal over a one second interval, and the output of integrator U81 provides a signal indicative of the power on the signal to be measured.

FIG. 7 is a schematic illustration of an integrator for calculating total WDM power such as integrator 490 in FIG. 4a above.

Integrator 700 is comprised the following components:
U103 is a logarithmic integrator model number AD8304ARU manufactured by Analog Devices, Inc. U103 has a dynamic range of 160 dB.

Integrator U103 is powered by 2.5 volts. Accordingly, the rail voltages of plus 18 and minus 18 volts provided in FIG. 6 are modified by power regulation chips U108 and U105, which may be for example, model numbers LN79L05ACM and MAX1735EUK25-T, respectively. The remaining components of integrator 490 are conventional.

In system 700, the output of photodiode P1 in FIG. 6 is provided to input INPT, and a logarithmic output indicative of the total power into photodiode P1 is provided.

Integrator 700 further comprises the following parts.

C339, C341, C342, C340, each have a value of 0.0047 μF

R158, R154, R155, R156 each have a value 10 kohms.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. For use in an optical carrier strength monitor, an apparatus to process a plurality of spatially-separated, data-modulated carriers of a wavelength-division multiplexed (WDM) signal, comprising:
a plurality of optical modulators arranged so that each receives a corresponding one of the plurality of data-modulated carriers; and
a control module adapted to actuate at least one of the plurality of optical modulators such that a carrier identifier is applied to at least one of the plurality of carriers, whereby the at least one of the plurality of data-modulated carriers is modulated with data and a carrier identifier.

2. The apparatus of claim 1, further comprising a demultiplexer configured to receive the WDM signal and form the plurality of spatially-separated carriers.

3. The apparatus of claim 1, further comprising a multiplexer configured to receive the spatially-separated carriers from the outputs of the plurality of optical modulators and to combine the spatially-separated carriers to form a second WDM signal.

4. The apparatus of claim 3, further comprising:
an optical tap optically coupled to the multiplexer output and arranged to tap a portion of the second WDM signal; and
a photosensor to transduce the tapped portion of the second WDM signal and form a transduced signal; and
a strength calculation module configured to receive the transduced signal and to calculate the strength of the at least one of the plurality of carriers.

5. The apparatus of claim 4, wherein the strength calculation module comprises a rectifier and an integrator that together determine the strength of the at least one of the plurality of carriers.

6. The apparatus of claim 5, wherein the strength calculation module further comprises a bandpass filter to selectively pass a portion of the transduced signal corresponding to the carrier identifier, and to provide the portion of the transduced signal to the rectifier.

7. The apparatus of claim 1, wherein the modulators are comprised of actuatable grating elements of a diffraction grating.

8. The apparatus of claim 7, wherein the diffraction grating is a diffraction grating of a dynamic channel equalizer.

9. The apparatus of claim 8, wherein the control module applies the carrier identifier to only a selected one the plurality of data-modulated carriers during a selected time interval.

10. The apparatus of claim 9, wherein the control module controls each of the plurality of modulators with a corresponding electronic signal having a DC component, and a selected one of the plurality of modulators corresponding to the selected one of the plurality of carriers with an AC component to apply the carrier identifier, whereby the channels are equalized and the selected one of the plurality of carriers is modulated.

11. For use in an optical carrier strength monitor, an apparatus for processing a plurality of spatially-separated, data-modulated carriers of a wavelength-division multiplexed (WDM) signal, comprising:
a plurality of optical modulators arranged so that each receives a corresponding one of the plurality of data-modulated carriers; and
a control module adapted to modulate only a selected subset of the plurality of optical modulators during a given time interval, so as to apply a corresponding carrier identifier to each of a subset of the plurality of data-modulated carriers, whereby each of the subset of carriers is modulated with data and a carrier identifier.

12. The system of claim 11, wherein the selected subset of the plurality of optical modulators consists of only one of the optical modulators.

13. The system of claim 11, further comprising a spectral demultiplexer configured to receive the WDM signal and form the plurality of spatially separated carriers.

14. The system of claim 12, wherein the control module is adapted to modulate at least two of the plurality of modulators to apply a common carrier identifier to each of a corresponding at least two of the plurality of carriers, application of the common identifier to a first of the at least two of the plurality of carriers and a second of the at least two of the plurality of carriers occurring sequentially.

15. For use in an optical carrier strength monitor, an apparatus for processing a plurality of spatially-separated carriers of a wavelength-division multiplexed (WDM) signal, comprising:
a plurality of optical modulators, each arranged to receive a corresponding one of the plurality of spatially-separated carriers; and
a control module adapted to control a first of the plurality of optical modulators to apply a carrier identifier to a first of the plurality of the carriers, and to control a second of the plurality of optical modulators to apply the carrier identifier to a second of the plurality of the optical carriers, the modulation of the first of the plurality of optical modulators and the second of the plurality of modulators being applied sequentially.

16. The apparatus of claim 15, further comprising a demultiplexer configured to receive the WDM signal and form the spatially-separated carriers.

17. The apparatus of claim 16, further comprising a multiplexer configured to receive the spatially-separated carriers from the outputs of the plurality of optical modulators and to combine the spatially-separated carriers to form a second WDM signal.

18. The apparatus of claim 17, further comprising: an optical tap optically coupled to the multiplexer output and arranged to tap a portion of the second WDM signal; a photosensor to transduce the tapped portion of the second WDM signal; and a strength calculation module configured to receive the transduced signal of the second WDM signal and to calculate the strength of the at least one of the plurality of carriers.

19. The apparatus of claim 18, wherein the strength calculation module comprises a rectifier and an integrator to calculate the strength of the at least one of the plurality of carriers.

20. The apparatus of claim 17, wherein the strength calculation module further comprises a bandpass filter to selectively pass a portion of the tranduced signal corresponding to the carrier identifier, and to provide the portion of the tranduced signal to the rectifier.

21. A method of processing at least one data-modulated carrier of a wavelength-division multiplexed (WDM) signal including a plurality of data-modulated carriers, comprising a step of:
modulating the at least one of a plurality of data-modulated carriers with a carrier identifier, the plurality of data-modulated carriers being spatially separated.

22. The method of claim 21, further comprising a step of spatially-separating the plurality of data-modulated carriers prior to the step of modulating.

23. The method of claim 21, further comprising steps of:
multiplexing the plurality of data-modulated carriers to from a second wavelength-division multiplexed (WDM) signal;
tapping a portion of the second WDM signal;
transducing the portion to form an electronic signal; and
calculating an output indicative of the strength of the at least one of the plurality of data-modulated carriers by processing the electronic signal.

24. The method of claim 23, wherein the step of calculating an output comprises rectifying the electronic signal.

25. The method of claim 24, wherein the step of calculating an output further comprises integrating the rectified electronic signal.

26. The method of claim 21, wherein the step of modulating comprises modulating a diffraction grating.

27. The method of claim 26, wherein the diffraction grating is a component of a dynamic channel equalizer.

28. A method of measuring the strength of one of a plurality of carriers comprising a wavelength-division multiplexed (WDM) signal, using a dynamic channel equalizer (DCE) including a plurality of actuatable elements, comprising steps of:
equalizing the strengths of the plurality of carriers by actuating at least one of the plurality of actuatable elements; and
modulating the one of the plurality of carriers with a carrier identifier.

29. The method of claim 28, further comprising a step of demultiplexing the plurality of carriers to spatially separate the plurality of carriers prior to the step of equalizing and the step of modulating.

30. The method of claim 28, further comprising a step of multiplexing the plurality of plurality of carriers to from a wavelength-division multiplexed (WDM) signal, the step of multiplexing occurring after the step of equalizing and the step of modulating.

31. The method of claim 28, wherein the step of equalizing and the step of modulating are achieved at the same time by actuating the grating elements of a diffraction grating.

32. The method of claim 30, further comprising a step of tapping a portion of the WDM signal, and a step of transducing the tapped portion to form an electronic signal, the step of tapping and the step of transducing occurring after the step of tapping.

33. The method of claim 32, further comprising a step of calculating an output indicative of the strength of the one of the plurality of carriers by processing the electronic signal.

34. The method of claim 33, wherein the step of calculating comprises a step of rectifying the electronic signal and a step of integrating the rectified signal.
